(19) United States
(12) Patent Application Publication
(10) Pub. No.: US 2003/0197301 A1
(43) Pub. Date: Oct. 23, 2003

(54) Process for the production of a transparent flat film from thermoplastic polyurethane and use thereof

(76) Inventors: Juergen Winkler, Langenfeld (DE); Joerg Nickel, Dormagen (DE); Klaus Meyer, Dormagen (DE); Henricus Peerlings, Solingen (DE)

Correspondence Address: BAYER POLYMERS LLC, 100 BAYER ROAD, PITTSBURGH, PA, 15205, US

(21) Appl. No.: 10/318,312

(22) Filed: Dec. 12, 2002

(30) Foreign Application Priority Data
Dec. 14, 2001 (DE) 10161387.3

(51) Int. Cl. B29C 43/24

(52) U.S. Cl. 264/145; 264/175; 264/319

(57) ABSTRACT

The present invention provides a process for the production of a transparent flat film from thermoplastic polyurethane (TPU) by introduction of the thermoplastic polyurethane between sheets of a higher-melting material. The transparent flat film may find use in optical applications.

### FIELD OF THE INVENTION

The present invention relates to a process for the production of a transparent flat film from thermoplastic polyurethane (TPU), wherein the film is obtained by introducing the TPU between sheets of a higher-melting material, passing the material between two contrarotating rolls and subsequently removing the sheets.

### BACKGROUND OF THE INVENTION

Thermoplastic polyurethanes (TPU) are of great industrial significance due to their good elastomer properties and melt processability. A review of the production, properties and applications of TPU may be found, for example. in G. Becker, D. Braun, Kunststoff-Handbuch, volume 7, “Polyurethane”, Munich, Vienna, Carl Hanser Verlag, 1983 or in M. Szycher, Handbook of Polyurethanes, CRC Press LLC, Boca Raton, Fla. USA, 1999.

The processing of plastics to yield flat films is a process which has long been known and is described, for example, in “Handbuch der Kunststoffextrusionstechnik”, Hensen, Knappe & Potente, part II, “Extrusionsanlagen”, Hanser Verlag, Munich, Vienna, 1986.

Transparent TPU flat films are normally produced by melt-processing the material in an extruder, wherein it is subsequently pressed one or more times. Among the disadvantages of said process are elevated handling costs, the risk of soiling by dust, pressing defects, formation of deposits and sticking to the polishing rolls.

When thermoplastic polyurethanes are converted into flat films, gel particles, which are disruptive to the optical quality of the product, are often observed. This is particularly disruptive with transparent grades (as, for example, described in EP-A 1 090 940) which, in addition to transparency, are also required to exhibit light stability and flexibility.

### SUMMARY OF THE INVENTION

The present invention therefore provides a process for the production of defect-free, transparent TPU flat films, in which it is possible to dispense with labor-intensive pressing operations and in which the problematic issues of soiling, pressing defects, formation of deposits and sticking to polishing rolls are greatly reduced or eliminated.

### DETAILED DESCRIPTION OF THE INVENTION

The present invention will now be described for purposes of illustration and not limitation.

The process according to the present invention produces a transparent, smooth, defect-free TPU flat film in a single step, i.e., without additional pressing of the flat films.

The present invention provides a process for the production of a transparent flat film from thermoplastic polyurethane (TPU flat film), wherein

a) a molten thermoplastic polyurethane (TPU) with a temperature of 150° C. to 220° C. is introduced between two sheets of a higher-melting thermoplastic material with a temperature of 0° C. to 80° C.,

b) the product from a) is passed between two contrarotating rolls with a temperature of 10° C. to 70° C.,

c) cooling is then performed,

d) cutting is optionally performed, and

e) the sheets of the higher-melting plastic are removed mechanically.

Polycarbonate may preferably be used as the higher-melting material by virtue of its good dimensional stability at low wall thickness, its elevated melting point and optical clarity (optionally required for assessing defects in the flat film). In addition to polycarbonate, other polymers, such as for example polyamide, polyesters, polyolefins, mixtures thereof and polycarbonate blends, may also be used. A review of the production, properties and applications of polycarbonates may be found, for example, in Kunststoff-Handbuch (G. Becker, D. Braun, volume 3/1 “Polycarbonate, Polyacetale, Polyester, Celluloseester”, Munich, Vienna, Carl Hanser Verlag, 1992 or in “Handbook of Polycarbonate Science and Technology” (D. Legrand, J. Bendler), New York, Basel, Marcel Dekker, 2000.

The sheets of the higher-melting plastic used may be of a thickness of 0.1 mm to 5 mm, preferably of 0.3 mm to 3 mm and particularly preferably of 0.5 mm to 2 mm.

The molten TPU in the present invention may preferably be an aliphatic, transparent TPU, such as for example that described in EP-A 1 090 940.

The TPU flat film produced using the process according to the present invention may have a thickness of 0.1 mm to 5 mm, preferably of 0.3 mm to 3 mm and particularly preferably of 0.5 mm to 2.5 mm.

The thermoplastic polyurethane (TPU) may preferably be melted by means of a extruder before being introduced between the sheets of the higher-melting plastic.

Once removed from the TPU flat film, the sheets of higher-melting plastic may preferably be reused in step a) of the process.

The TPU flat films produced using the process according to the present invention may be particularly useful for optical applications.

The following Examples are intended to illustrate the invention in greater detail.

### EXAMPLES

### Comparative Example 1

A homogeneous melt was produced from TPU pellets (Texin® DP7-3007, Bayer Corp.) in an extruder (melt temperature approx. 160° C.). Using a flat film die, the TPU melt was introduced into a chill roll/polishing stack. The flat film was formed, sized and polished from the melt in the polishing stack at roll temperatures of 20° C. After cooling, the flat film was cut. The cut flat films were pressed with matted sheets (roughness height 1.5-2 μm) and then with high gloss polished sheets in platen presses at temperatures of approx. 140° C. In this manner, a transparent, light-stable TPU flat film of a thickness of 2 mm was produced.

### Example 2

A homogeneous melt was produced from TPU pellets (Texin® DP7-3007, Bayer Corp.) in an extruder (melt temperature approx. 160° C.). Using a flat film die, the TPU melt was introduced into a chill roll/polishing stack. Simultaneously, two PC sheets at room temperature ran into the roll nip, such that the TPU melt was introduced between the PC sheets. The melt was formed, sized and polished between the PC sheets in the polishing stack at roll temperatures of approx. 20° C. After cooling, the multilayer sheet was cut or wound into reels. The two PC sheets remained on the TPU flat film to provide protection until the ultimate use of the film and were then simply peeled off the TPU flat film without leaving any residues. The PC sheets may be reused. In this manner, a transparent, light-stable TPU flat film of a thickness of 2 mm was produced.

Although the present invention has been described in detail in the foregoing for the purpose of illustration, it is to be understood that such detail is solely for that purpose and that variations can be made therein by those skilled in the art without departing from the spirit and scope thereof except as it may be limited by the appended claims.

What is claimed is:

1. A process for the production of a transparent flat film from thermoplastic polyurethane comprising:
introducing a molten thermoplastic polyurethane (TPU) with a temperature of 150° C. to 220° C. between two sheets of a higher-melting thermoplastic with a temperature of 0° C. to 80° C.;
passing the higher melting thermoplastic sheets with TPU therebetween between two contrarotating rolls with a temperature of 10° C. to 70° C.;
cooling the higher melting thermoplastic sheets with TPU therebetween;
optionally cutting the higher melting thermoplastic sheets with TPU therebetween; and
mechanically removing the sheets of higher melting plastic from the flat film.

2. The process according to claim 1, wherein the thermoplastic polyurethane (TPU) is an aliphatic thermoplastic polyurethane.

3. The process according to claim 1, wherein the flat film of thermoplastic polyurethane (TPU) has a thickness of 0.1 mm to 5 mm.

4. The process according to claim 1, wherein the higher-melting plastic comprises polycarbonate.

5. The process according to claim 1, wherein the sheets of higher-melting plastic have a thickness of 0.1 mm to 5 mm.

6. The process according to claim 1, wherein the sheets of the higher-melting plastic are reused in the process.

7. The process according to claim 1, wherein the flat film of thermoplastic polyurethane (TPU) has a thickness of 0.3 mm to 3 mm.

8. The process according to claim 1, wherein the flat film of thermoplastic polyurethane (TPU) has a thickness of 0.5 mm to 2.5 mm.

9. The process according to claim 1, wherein the sheets of higher-melting plastic have a thickness of 0.3 mm to 3 mm.

10. The process according to claim 1, wherein the sheets of higher-melting plastic have a thickness of 0.5 mm to 2 mm.
